(19) United States
(12) Patent Application Publication
(10) Pub. No.: US 2003/0013486 A1
(43) Pub. Date: Jan. 16, 2003

(54) Radio communication terminal

(75) Inventor: Keisuke Ozeki, Tokyo (JP)

Correspondence Address: SCULLY SCOTT MURPHY & PRESSER, PC, 400 GARDEN CITY PLAZA, GARDEN CITY, NY, 11530

(73) Assignee: NEC Corporation, Tokyo (JP)

(21) Appl. No.: 10/194,648

(22) Filed: Jul. 12, 2002

(30) Foreign Application Priority Data
Jul. 16, 2001 (JP) 214652/2001

(51) Int. Cl. H04B 1/38

(52) U.S. Cl. 455/557

(57) ABSTRACT

The radio communication terminal 100 includes an internal data analyzer part 105 and permits collective management of not only data transmitted and received by itself but also data transmitted and received by a data processing terminal 109 by using it as a communication means. A predetermined data is detected from the communication data and the detected data is stored in a memory.

### BACKGROUND OF THE INVENTION

This application claims benefit of Japanese Patent Application No. 2001-214652 filed on Jul. 16, 2001, the contents of which are incorporated by the reference.

The present invention relates to radio communication terminals and, more particularly, to radio communication terminals, which are connected to such data processing terminals as PCs (Personal Computers) and PDAs (Personal Digital Assistants) for communication with a radio base station in radio sections.

Heretofore, telegraphic and telephone sets and also facsimile sets have usually been used as communication means. However, with the progress of computer network techniques and radio communication techniques, portable telephone terminals capable of transmitting and receiving electronic mails (e-mails) and reading www (world wide web), and also radio communication terminals of PHS (Personal Handy Phone system) and the like, are being rapidly spread as new communication means.

Prior art examples in this field are disclosed in, for instance, Japanese Patent Laid-Open No. 2001-69260 entitled “Radio Communication Unit, Battery Unit, Charging Unit and Portable Terminal”. This disclosed technique has a purpose of permitting selection of an operating unit, which is best suited for the aim of use, without change of a single telephone number, thus permitting mutual reference of mail logs and telephone diaries among a plurality of versatile data units. To this end, each radio communication unit has a radio communication mechanism capable of radio transmitting and receiving data and also has a general purposed memory, in which files are stored in the file form of a predetermined operating system (OS). When an external data device is connected to a highly versatile external connector such as a compact flash type II, it is made ready for the external data unit to execute communication control or reading out and writing files from and in the versatile memory mechanism.

Where the radio communication terminal such as the above is used as communication means, with which a data processing terminal executes data communication, data of electronic mail transmission and reception executes in the data processing terminal and www reading history are preserved in the data processing terminal alone and can not be referred to by the radio communication terminal. Therefore, when it becomes necessary, for the radio communication terminal intending to execute electronic mail transmission or reception or www reading by itself, to confirm the data of electronic mail transmission and reception executed in the data communication terminal, www reading history, etc., an inconvenience is encountered that confirmation of the data processing terminal is the sole available means. In addition, the contents of data of electronic mails transmitted and received by the radio communication terminal by itself and the contents of data transmitted and received with the radio communication terminal used as communication means, are separately managed and cannot be collectively confirmed at a time.

### SUMMARY OF THE INVENTION

The present invention was made in view of the above problems and inconveniences inherent in the prior art, and it has an object of providing a radio communication terminal, which is connected to a data processing terminal and permits collective preservation of the communication contents therein even in the case of using a radio communication terminal as its data communication means.

According to an aspect of the present invention, there is provided a radio communication terminal for solely transmitting and receiving data to and from a radio base station and also connected to a data processing terminal such as a personal computer or a personal digital assistant for transmitting and receiving data in radio sections so as to be able to transmit and receive data in the processing terminal to and from the radio base station in radio sections, wherein the radio communication terminal further comprises a data analyzer part for analyzing and detecting data to be preserved or stored and internally storing the detected data in the data analyzer part among the data transmitted and received from and in the radio processing terminal.

The data analyzer part is disposed between a baseband part and an external interface part and controlled by a control part. A modem for executing data transform permitting data transmission, and reception with respect to the data processing terminal is externally connected. A modem for performing data transform permitting data transmission and reception with respect to the data processing terminal is internally provided. The internal modem is disposed between the data analyzer part and the baseband part. The radio communication terminal further comprises a storing part for storing the result of analysis in the data analyzer part under control of the control part. The detected data is mail address, mail content or URL.

According to another aspect of the present invention, there is provided a radio communication terminal for solely communication with a radio base station and also communication with the radio base station with connected state to a data processing terminal, wherein a predetermined data is detected from the communication data and the detected data is stored in a memory. The predetermined data mail address, mail content or URL.

Other objects and features will be clarified from the following description with reference to attached drawings.

### BRIEF DESCRIPTION OF THE DRAWINGS

FIG. 1 is a block diagram showing the construction of a first embodiment of the radio communication terminal according to the present invention;

FIG. 2 is a flow chart illustrating the operation of the control part 103 of the radio communication terminal 100 shown in FIG. 1; and

FIG. 3 is a block diagram showing the construction of a second embodiment of the radio communication terminal according to the present invention.

### PREFERRED EMBODIMENTS OF THE INVENTION

Preferred embodiments of the present invention will now be described with reference to the drawings.

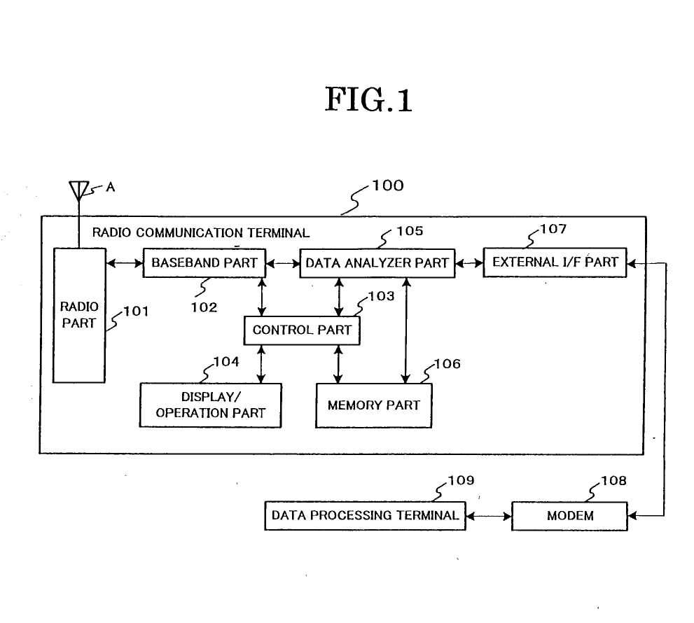

FIG. 1 is a block diagram showing the construction of a first embodiment of the radio communication terminal according to the present invention. The radio communication terminal 100 as shown in FIG. 1 is capable of communication with a radio base station (not shown), and it comprises a radio part 101 connected to an antenna A, a baseband part 102, a control part 103, a display/operation part 104, a data analyzer part 105, a memory part 106 and an external I/F (interface) part 107. The radio communication terminal 100 is connected via a modem (modulator/demodulator) 108 to an external data processing terminal 109. Output data from the data processing terminal 109 is coupled via the modem 108, the external I/F part 107, the data analyzer part 105 and the baseband part 102 to the radio part 101 and thence transmitted via the antenna A to a radio base station.

Transmission data is transmitted from the radio unit 101 via the antenna A to the radio base station in a radio section. On the other hand, data transmitted from the radio base station is received via the antenna A in the radio unit 101. The received data is processed via the baseband part 102, the data analyzer part 105, the external I/F part 107 and the modem 108 so as to be coupled to the data processing terminal 109.

The radio part 101 transmits the signal from the baseband part 102 via the antenna A to the radio base station, and supplies the received signal from the radio base station to the baseband part 102. The baseband part 102 executes baseband processing on the data inputted from the data analyzer part 105 and supplies the signal inputted from the radio part 101 and supplies the processed data to the radio part 101 and to the data analyzer part 105, respectively. The control part 103 controls the radio part 101, the baseband part 102, the display/operation part 104, the data analyzer part 105 and the memory part 106.

The display/operation part 104 includes a display part constituted by, for instance, a liquid crystal display panel for displaying data of letters and images designated by the control part 103, and supplies the operation contents inputted by the user from an operating part constituted by, for instance, a ten-key set keyboard to the control part 3. The data analyzer part 105 analyzes the data from the external I/F part 107, detects the data to be memorized, such as mail address, mail content, URL, etc. from header data contained in up-transmitted data, supplies the detected data after the analysis to the control part 103, and supplies the data before the analysis as transmitted data to the baseband part 102. The data analysis part 105 further executes similar analysis of data from the baseband part 102, detects the data to be memorized, such as mail address, mail content, URI, from the header data contained in the down-transmitted data, supplies the data after detected data analysis, and couples data before the analysis as received data to the external I/F part 107.

The control part 103 selects necessary data from the data after the analysis supplied from the data analyzer part 105, and stores the selected data in the memory part 106. The external I/F part 107 is an interface between the modem 108 and the radio communication terminal 100, and supplies an input from the modem 108 to the data analyzer part 105 and also an input from the data analyzer part 105 to the modem 108. The modem 108 executes data conversion for data transmission and reception between the data processing terminal 109 and the radio communication terminal 100, and supplies the data from the data processing terminal 109 to the external I/F part 107 and the data from the external I/F part 107 to the data processor terminal 109.

Now, the operation of the first embodiment of the radio communication terminal 100 as shown in FIG. 1 according to the present invention will be described in detail separately in connection with up-transmission (i.e., transmission from the data processing terminal 109 and down-transmission (i.e., transmission from the radio base station) from the radio base station.

In the case of the up-transmission, the modem 108 executes format transform of the transmitted data from the data processor terminal 109, and supplies the transformed data via the external I/F part 107 to the radio communication terminal 100. The data analysis part 105 executes analysis of data inputted from the external I/F 107. The data analysis part 105 detects the data to be stored, such as mail address, mail content and URL, from the header data contained in the up-transmitted data and the like, supplies the detected data after the analysis to the control part 103, and supplies the data before the analysis to the baseband part 102. The baseband part 102 executes baseband processing on the data, and supplies the processed data to the radio part 101. The radio part 101 transmits the data via the antenna A to the radio base station in radio sections.

In the case of the down-transmission, the transmitted data from the radio base station is received via the antenna A by the radio part 101 and supplied to the baseband part 102. The baseband part 102 executes the baseband processing on the received data, and supplies the processed data to the data analysis part 105. The data analyzer part 105 executes analysis of the inputted data, detects the data to be stored, such as mail address, mail content and URL, from the header data contained in the down-transmitted data and the like, supplies the detected data after analysis, and supplies the data before the analysis to the external I/F part 107. The external I/F part 107 supplies the data to the external modem 108 outside the radio communication terminal 100. The modem 108 executes the format transform, and supplies the data to the data processing terminal 109. As described, in either up- or down-transmission case, the data analyzer part 105 executes analysis of the inputted data, detects the data to be stored, such as mail address, main content and URL, from the header data contained in the up- or down-transmission data and the like, and supplies the data after detected data analysis to the control part 103.

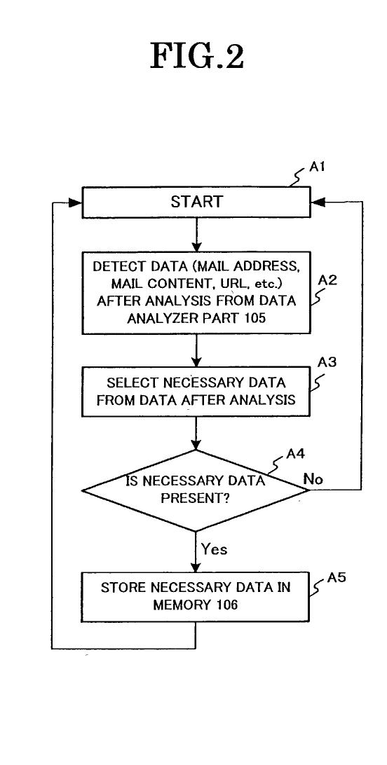

FIG. 2 is a flow chart illustrating the operation of the control part 103 of the radio communication terminal 100 shown in FIG. 1. The control part 103 starts the operation (step A1) and detects the data after the analysis from the data analyzer part 105 (step A2). The data analyzer part 105 detects the data to be stored, such as mail address, mail content, URL, from the header data contained in the transmitted data and the like. The control part 103 selects necessary data from the data after the analysis from the data analyzer part 105 (step A3), and checks whether the necessary data (i.e., data to be stored) are present (step A4). When the control part 103 detects that necessary data are present (“Yes” in step A4), the selected data is stored in the memory 106 (step A5). Then the routine goes back to the initial state (step A1) noted above. When the control part 103 detects no necessary data (“No” in step A4) on the other hand, the initial state is restored (step A1) without reservation of any data.

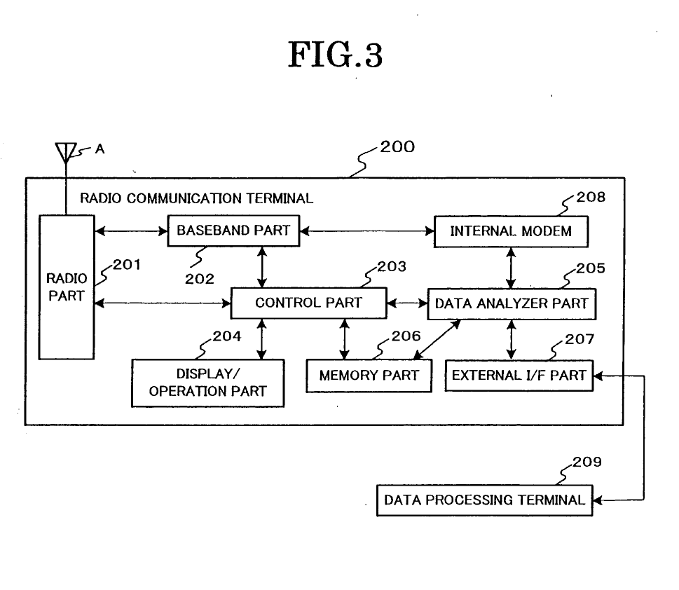

FIG. 3 is a block diagram showing the construction of a second embodiment of the radio communication terminal according to the present invention. Referring to FIG. 3, the radio communication terminal 200 comprises a radio unit 201 including an antenna A, a baseband part 202, a control part 203, a display/operation part 204, a data analyzer part 205, a memory part 206, an external I/F part 207 and an internal modem 208. A data processing terminal 209 is connected to the external I/F part 207 of the radio communication terminal 200. The second embodiment of the radio communication terminal 200 as shown in FIG. 3 is different from the first embodiment of the radio communication terminal 100 in that the radio communication terminal 200 has an internal modem 208 and that the data analyzer part 205 executes analysis of data from the external I/F part 207 and the internal modem 208.

The operation of the radio communication terminal 200 shown in FIG. 3 will now be described. The radio communication terminal 200 can transmit and receive the data via the data processing terminal 209 to and from the radio base station in radio sections. In the case of up-transmission (i.e., transmission from the data processing terminal 209), the transmission data is supplied from the data processing terminal 209 via the external I/F part 207 to the radio communication terminal 200. The data from the external I/F part 207 is analyzed in the data analyzer part 205 as described above. The data analyzer part 205 supplies the data before the analysis to the internal modem 208. The internal modem 208 executes the format transform of the data, and supplies the transformed data to the baseband part 202. The baseband part 202 executes baseband processing of the data, and supplies the processed data to the radio part 201. The radio part 201 transmits the data via the antenna A to the radio base station in radio sections. Likewise, in the case of down-transmission (i.e., transmission from the radio base station), the transmitted data from the radio base station is received via the antenna A by the radio part 201 and supplied to the baseband part 202. The baseband part 202 executes baseband processing of the data, and supplies the processed data to the internal modem 208. The internal modem 208 executes format transform of the data, and supplies the transformed data to the data analyzer part 205. The data analyzer part 205 executes the analysis of the data, and supplies the data before the analysis to the external I/F part 207. The external I/F part 207 supplies the data to the data processing terminal 209 outside the radio communication terminal 200.

Since the embodiment shown in FIG. 3 uses the internal modem 208 for the analysis of data in the format used in the data processing terminal 209, it has an advantage that the data analyzer part 205 can be readily constructed.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

As has been described in the foregoing, the radio communication terminal according to the present invention has the following pronounced practical effects. First, with the internal provision of the data analyzer part, which analyzes and detects the data to be preserved or stored in the radio communication terminal, it is possible to preserve the contents of data transmitted and received by the data processing terminal via the radio communication terminal. It is thus possible for the sole radio communication terminal to confirm the contents of data transmitted and received by the sole data processing terminal. This means that such convenience is obtainable that with confirmation of the URL accessed by the data processing terminal, such operation as mail transmission from the radio communication terminal can be easily executed with respect to the transmission of a mail received by the data processing terminal, which is connected to the URL by the sole radio communication terminal.

Also, with the storing, in the radio communication terminal, of both the contents of data transmitted and received in the sole radio communication terminal and the contents of data transmitted and received by the data processing means with the radio communication terminal as communication means, it is possible to obtain a convenience that both the contents of data transmitted and received by the sole radio communication terminal and the contents of data transmitted and received by the data processing terminal as the radio communication terminal as communication means can be collectively managed in a terminal.

Furthermore, with a modem internally provided in the radio communication terminal, the data analyzer part analyzes, via the internal modem, data of the format used in the data processing terminal. Thus, the data analyzer part can be readily constructed.

What is claimed is:

1. A radio communication terminal for solely transmitting and receiving data to and from a radio base station and also connected to a data processing terminal such as a personal computer or a personal digital assistant for transmitting and receiving data in radio sections so as to be able to transmit and receive data in the processing terminal to and from the radio base station in radio sections, wherein provided is a data analyzer for analyzing and detecting data to be preserved or stored based on the transmission and reception data and internally storing the detected data in the data analyzer part among the data transmitted and received from and in the radio processing terminal.

2. A radio communication terminal for solely transmitting and receiving data to and from a radio base station and also connected to a data processing terminal such as a personal computer or a personal digital assistant for transmitting and receiving data in radio sections so as to be able to transmit and receive data in the processing terminal to and from the radio base station in radio sections, wherein between a baseband part and an external interface part and controlled by a control part, provided is a data analyzer for analyzing and detecting data to be preserved or stored based on the transmission and reception data and internally storing the detected data in the data analyzer part among the data transmitted and received from and in the radio processing terminal.

3. The radio communication terminal according to claim 1 or 2, wherein a modem for executing data transform permitting data transmission, and reception with respect to the data processing terminal is externally connected.

4. The radio communication terminal according to claim 1 or 2, wherein a modem for performing data transform permitting data transmission and reception with respect to the data processing terminal is internally provided.

5. The radio communication terminal according to claim 1 or 2, wherein the internal modem is disposed between the data analyzer part and the baseband part.

6. The radio communication terminal according to one of claims 1 to 5, which further comprises a storing part for storing the result of analysis in the data analyzer part under control of the control part.

7. The radio communication terminal according to one of claims 1 to 6, wherein the detected data is mail address, mail content or URL.

8. A radio communication terminal for solely communication with a radio base station and also communication with the radio base station with connected state to a data processing terminal, wherein a predetermined data is detected from the communication data and the detected data are stored in a memory.

9. The radio communication terminal according to claim 8, wherein the predetermined data mail address, mail content or URL.
